(19) United States
(12) Patent Application Publication
(10) Pub. No.: US 2024/0062677 A1
(43) Pub. Date: Feb. 22, 2024

(54) SYSTEM AND METHOD FOR PROVIDING EDUCATION USING MODELING

(71) Applicant: DABIDA CORP., Anyang-si (KR)

(72) Inventors: Eunseung LEE, Gwangju (KR); Hyunsoo KIM, Yongin-si, Gyeonggi-do (KR)

(73) Assignee: DABIDA CORP., Anyang-si, Gyeonggi-do (KR)

(21) Appl. No.: 17/985,158

(22) Filed: Nov. 11, 2022

(30) Foreign Application Priority Data
Aug. 18, 2022 (KR) 10-2022-0103428
Oct. 31, 2022 (KR) 10-2022-0142883

(51) Int. Cl. G09B 23/00; G06V 30/142; G06V 30/14; G06F 40/40

(52) U.S. Cl. CPC G09B 23/00; G06V 30/1423; G06V 30/1456; G06F 40/40

(57) ABSTRACT

A system and method for providing education using modeling of the present disclosure is configured to provide predetermined education and study to a user using a model in an online environment. The present disclosure provides a system for providing education using modeling, the system includes: a user terminal; and a modeling server connected with the user terminal such that communication is possible, and configured to construct models for various fields of study on the basis of predetermined data, wherein the modeling server is configured to: receive fundamental data from the user terminal; receive a command giving an instruction related to the received fundamental data from the user terminal; create model information corresponding to a field of study designated by the command using the received fundamental data; and transmit the created model information to the user terminal.

### CROSS REFERENCE TO RELATED APPLICATION

The present application claims priority to Korean Patent Application No. 10-2022-0103428, filed on Aug. 18, 2022, and Korean Patent Application No. 10-2022-0142883, filed on Oct. 31, 2022, the entire contents of which is incorporated herein for all purposes by this reference.

### BACKGROUND OF THE INVENTION

### Field of the Invention

The present disclosure relates to a system and method for providing a user with predetermined education and study in an online environment, and in more detail, a system and method for providing education about a predetermined field of study using modeling.

### Description of the Related Art

With the development of technologies, various education systems and methods have been developed to provide users, that is, students with education in an online environment, in addition to common education that is performed in classrooms. Such online education systems and methods can provide education to users connected through a network regardless of places, so it is possible to more conveniently and effectively educate users.

In general, an online education system may include a server positioned at a remote place and managing the entire system, and a terminal connected to the server to be able to perform communication and disposed close to a user. A user receives various education data through communication with the server using the terminal and studies the received education data, and the result of the performed study can be transmitted to the server for evaluation and storage.

Recently, for effective education, online systems and methods employ techniques that perform education while interacting with users in real time. These techniques can be applied to various fields of study and education methods thereof and may be very advantageous in induction of interest and attendance of users. For example, a modeling method of several education methods can increase understanding of users by providing detailed models of specific fields of study on the basis of fundamental data. Accordingly, it is required to employ a modeling method, which is appropriately configured to use interaction with users, in order to enhance the effect of education in online systems and methods.

### SUMMARY OF THE INVENTION

The present disclosure has been made in an effort to solve the problems described above and an objective of the present disclosure is to provide a system and method configured to perform education in a predetermined field of study using modeling.

In order to achieve the objectives, the present disclosure may provide a system for providing education using modeling, the system including: a user terminal; and a modeling server connected with the user terminal such that communication is possible, and configured to construct models for various fields of study on the basis of predetermined data, wherein the modeling server is configured to: receive fundamental data from the user terminal; receive a command giving an instruction related to the received fundamental data from the user terminal; create model information corresponding to a field of study designated by the command using the received fundamental data; and transmit the created model information to the user terminal.

The fundamental data may be obtained from sensor devices provided for the user terminal. The fundamental data may be directly input into the user terminal by a user.

The command may include: a first command designating a field of stud to be modeled and a subject in the field of study; and a second command designating a processing type for the received fundamental data under the designated field of study and subject.

The command may include handwriting information created by handwriting on the user terminal by a user. In order to recognize and analyze the command, the modeling server may be configured to: recognize handwriting by the user from handwriting information of the command; extract words from the recognized handwriting; and analyze meanings of the command on the basis of the extracted words.

In order to create the model information, the modeling server may be configured to: determine a field of study to be modeled and a subject tin the field of study on the basis of the first command; determine a processing type for the received fundamental data on the basis of the second command; select a library corresponding to the determined field of study and subject by searching a database in a database module of the modeling server on the basis of the field of study and the subject; and process the fundamental data to create the model information in accordance with the determined processing type using contents in the selected library.

In order to process the fundamental data, the modeling server may be configured to: analyze the fundamental data; construct a graph using the analyzed fundamental data; and calculate various parameters related to the created model.

The modeling server may be configured to further make a report including information about the graph and the parameters and may be configured to transmit the constructed graph and report to the user terminal as the model information.

The system and method for providing education using modeling of the present disclosure can receive fundamental data from a user, create a model for a field of study and a subject designated using the received fundamental data, and provide the created model to the user. According to the system and method of the present disclosure, a user can active collect fundamental data about specific phenomenon and can specify modeling about a field of study and a subject, which the user is interested in, for the collected data. The model created by the system and method of the present disclosure can be provided in real time to a user together with detailed additional information. Accordingly, the system and method of the present disclosure provide objective and detailed information about various items of phenomenon through an interactive procedure, whereby it is possible to induce a user to have more interest and actively participate in learning of the corresponding study and it is possible to enable the user to quickly and deeply understand the study.

### BRIEF DESCRIPTION OF THE DRAWINGS

The above and other objectives, features and other advantages of the present invention will be more clearly understood from the following detailed description when taken in conjunction with the accompanying drawings, in which:

FIG. 1 is a schematic view showing a system for providing education using modeling according to the present disclosure;

FIG. 2 is a schematic view showing the structure of a database in a database module of a modeling server in the system for providing education of FIG. 1;

FIG. 3 is a flowchart showing a method for providing education using modeling according to the present disclosure;

FIG. 4 is a flowchart showing a model information creation step in detail in the method for providing education of FIG. 3;

FIG. 5 is a flowchart showing in detail a fundamental data process step of FIG. 4; and

FIGS. 6 and 7 are schematic views showing examples of the method for providing education of the present disclosure.

### DETAILED DESCRIPTION OF THE INVENTION

Examples of a system and method for providing education using modeling according to the present disclosure are described hereafter in detail with reference to the accompanying drawings.

In the description of the examples, the same or similar components are given the same reference numerals regardless of the drawings and are not repeatedly described. Terms “module” and “unit” that are used for components in the following description are used only for the convenience of description without having discriminate meanings or functions. In the following description, if it is decided that the detailed description of known technologies related to the present disclosure makes the subject matter of the embodiments described herein unclear, the detailed description is omitted. Further, the accompanying drawings are provided only for easy understanding of embodiments disclosed in the specification, the technical spirit disclosed in the specification is not limited by the accompanying drawings, and all changes, equivalents, and replacements should be understood as being included in the spirit and scope of the present disclosure.

Terms including ordinal numbers such as “first”, “second”, etc., may be used to describe various components, but the components are not to be construed as being limited to the terms. The terms are used only to distinguish one component from another component.

It is to be understood that when one element is referred to as being “connected to” or “coupled to” another element, it may be connected directly to or coupled directly to another element or be connected to or coupled to another element, having the other element intervening therebetween. On the other hand, it should to be understood that when one element is referred to as being “connected directly to” or “coupled directly to” another element, it may be connected to or coupled to another element without the other element intervening therebetween.

Singular forms are intended to include plural forms unless the context clearly indicates otherwise.

It will be further understood that the terms “comprise”, “include”, or “have” used in this specification, specify the presence of stated features, steps, operations, components, parts, or a combination thereof, but do not preclude the presence or addition of one or more other features, numerals, steps, operations, components, parts, or a combination thereof. Further, for the same reason, it should be understood that the present disclosure includes combinations without some features, numbers, steps, operations, components, and parts from combinations of relevant features, numbers, steps, operations, components, and parts described using the terms stated above unless they depart from the technical objectives and effects intended in the embodiments disclosed herein.

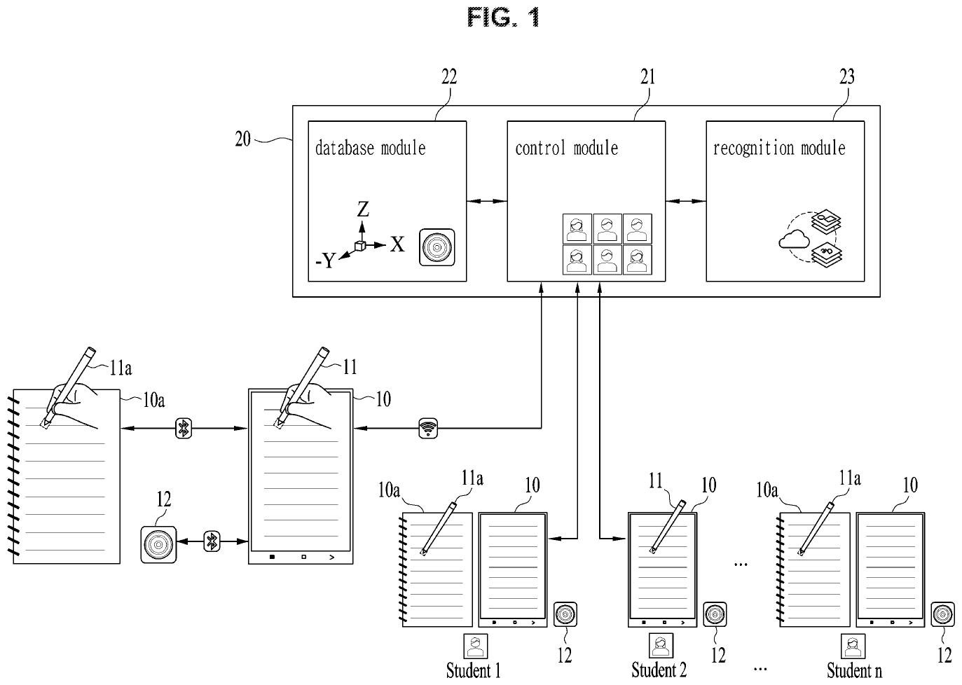

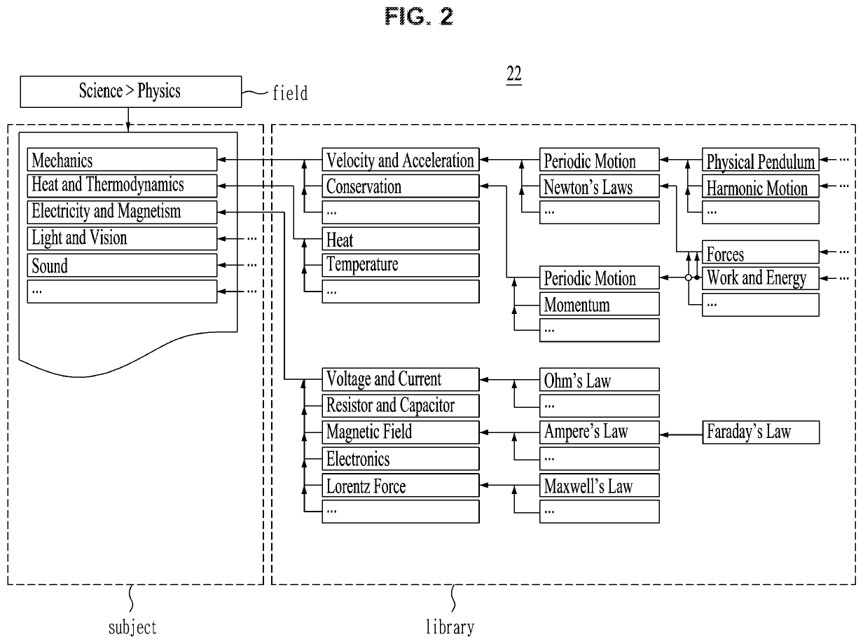

FIG. 1 is a schematic view showing a system for providing education using modeling according to the present disclosure. FIG. 2 is a schematic view showing the structure of a database in a database module of a modeling server in the system for providing education of FIG. 1. The configuration of an example of a system for providing education according to the present disclosure is described hereafter in detail with reference to the drawings.

As briefly discussed above, a system for providing education according to the present disclosure is configured to provide a model belonging to a predetermined field of study to users through interaction with the users, that is, to learners or students. Since such a model include detailed information about the field of study and relevant subjects, it enables students who are users to deeply understand the field of study and the relevant subjects and to more actively participate in education. Next, the system and method for providing education will be described in connection with modeling of physics that is any specific field of study, but the system and method may be intactly applied to provide education using modeling in other fields of study, for example, mathematics, chemistry, sociology, etc. substantially without a change in the principle and configuration thereof.

Referring to FIG. 1, first, the system for providing education according to the present disclosure may include a user terminal 10.

In the system of the present disclosure, the user terminal 10 is required to receive various items of information including education data from external devices and to process the received information in order to perform education. For this reason, the user terminal 10 is configured to have ability that can communicate with external devices and process electronic information, and for example, may be a smart device such as a personal computer (PC), a smartphone, and a tablet PC. FIG. 1 shows, as an example, a user terminal 10 that is a tablet PC. The system and method of the present disclosure will be described below with reference to the example, but the user terminal 10, as stated above, may be other types of terminals having communicating and processing ability.

In more detail, the user terminal 10 may include a display for visually outputting information, an input device for inputting various types of information, a storage device that stores information required for education, and a control device that controls operation of these devices. A physical keyboard, a virtual keyboard implemented on a display (that is, a touch pad), a mouse, etc. may be generally used as the input device of the various devices of the terminal 10. Meanwhile, more effective education may be possible when responses of users are provided in real time while education proceeds, and theses real-time responses can be easily achieved by handwriting of the users. Substantially, handwriting can easily adopt even users who are familiar with common offline education to online education. For this reason, the user terminal 10 may include an input tool 11 for writing input of a user. FIG. 1 shows a stylus pen 11 as an example of the input tool 11. The system and method of the present disclosure will be described below with reference to this example, but the input tool 11 may be replaced with other tools that perform the same function. When handwriting is input on a display, which enables inputting, of the user terminal, for example, a touch panel using the stylus pen 11, an electrical signal is generated by pressure or static electricity that is generated when the handwriting is input, and the handwriting by the user can be recognized and displayed by the electrical signal.

Meanwhile, the user terminal 10 may include an additional auxiliary input device to input handwriting. As shown in FIG. 1, as an auxiliary input device, the user terminal 10 may include a smart paper 10a and a smart pen 11a. The smart paper 10a is an input tool having several micro patterns printed on common paper and the smart pen 11a is an input tool formed by combining a sensor that can recognize the micro patterns (e.g., an optical image detection (01D) sensor) and a communication device (e.g., a near field communication module such as Bluetooth) with a common pen. When a user writes on the smart paper 10a using the smart pen 11a, characters are printed on the paper 10a, and simultaneously, the sensor can recognize micro patterns on the writing path during writing. Data such as coordinate values, angular velocity, acceleration, etc. are obtained on the basis of the recognized micro patterns, and such data can be transmitted to adjacent other devices, that is, the user terminal 10 through the communication device of the smart pen 11a. The handwriting of the user can be recognized in the user terminal 10 by the transmitted data, and the recognized handwriting can be displayed on the user terminal 10. That is, the handwriting on the paper by a user can be changed into data and immediately mirrored on an electronic device and a display by the smart paper 10a and the smart pen 11a. Such auxiliary input devices 10a and 11a use handwriting on paper, so it is possible to more easily adapt users who familiar with offline education to online education. In the following description, the stylus pen 11 and the smart pen 11a are each briefly referred to as “pen” for the convenience of description.

The user terminal 10 may include various sensors 12 as auxiliary input devices. The sensors 12 may be disposed outside the user terminal 10 and may be connected with the user terminal 10 using various wired and wireless communication protocols. The sensors 12 may be configured to obtain various fundamental data for modeling and input the fundamental data to the user terminal 10. For example, the sensors 12 may include a camera, an acceleration sensor, a distance sensor, a gravity sensor, a temperature and humidity sensor, etc. As described above, the sensors 12 can be very usefully used to collect fundamental data for modeling particularly in the field of science. Meanwhile, as shown in the figures, when the user terminal 10 is a smart device such as a tablet PC, various sensors including a camera are fundamentally disposed therein. Accordingly, the sensors of the user terminal 10 may replace the sensors 12 or may be used with the sensors 12 to collect fundamental data for modeling.

The system for providing education of the present disclosure may include at least on user terminal 10 described above and several user terminals 10 may be included in the system to simultaneously provide several users with an education service.

The system for providing education of the present disclosure may include a modeling server 20 connected with the user terminal 10 such that communication is possible. The modeling server 20 may be configured to construct models for various fields of study on the basis of predetermined data and to transmit the constructed models to the user terminal 10 for the purpose of education. The modeling server 20, as shown in FIG. 1, may be connected with at least one user terminal 10 and may be connected with several user terminals 10 such that communication is possible in order to simultaneously provide several users with an education service based on modeling.

The modeling server 20 may be a computer device that can function as a common server that transmits/receives information through a wired/wireless network under a server-client infrastructure to construct and transmit a model. That is, the modeling server 20, fundamentally in terms of hardware, may include an I/O device, a storage device, a communication device, and a control device that perform data transmission/reception and processing, and, in terms of function, as shown in FIG. 1, may be composed of a control module 21, a database module 22, and a recognition module 23. These modules 21 to 23 may be separated from each other in terms of hardware, if necessary, and may be individual servers, that is, a control server 21, a database server 22, and a recognition server 23, respectively.

First, the control module 21 may be configured to control all the operations that are performed not only in the modeling server 20, but in the system for providing education. For this control, the control module 21 is configured to communicate direct with an external user terminal 10 and can control and manage reception of predetermined data or information from a terminal 10 for providing an education service and transmission of predetermined data or information to the terminal 10. The control module 21 may be configured to communicate with also the database module 22 and the recognition module 23 in order to control operation of the modules 22 and 23. The control module 21 may be configured to substantially perform in person even work of constructing a model in accordance with relevant fundamental data.

The database module 22 is configured to keep various items of information required for modeling in a database type. In more detail, the database module 22 can operate individual databases of items of information required for modeling, respectively, in relation to various fields of study. As an example, as shown in FIG. 2, the database of the database module 22 may include various subjects in relation to a specific field of study, for example, physics of science, and may include libraries related to the subjects, respectively. Such libraries include contents related to corresponding fields of study and subjects, respectively, and for example, these contents may include a relevant theory, a relevant formula, a modeling technique based on the formula, a method of calculating parameters, etc. The databases exemplified in FIG. 2 may exist in the database module 22 for individual fields of study such as mathematics, chemistry, and sociology. Accordingly, the database module 22 can provide the contents in corresponding libraries to the control module 21 in response to requests from the control module 21 for modeling.

The recognition module 23 may be configured to recognize handwriting input that is provided to the user terminal. In more detail, the user terminal 10 converts handwriting of a user into predetermined electronic data, that is, handwriting information, and the recognition module 23 can receive the handwriting information and recognize the handwriting of the user from the handwriting information. The recognition module 23 can also extract words from the recognized handwriting and analyze the meanings of the words. Such handwriting recognition and analysis by the recognition module 23 may be performed by techniques based on artificial intelligence or machine learning. The recognition module 23 recognizes and analyzes handwriting from handwriting information in response to a request from the control module 21, and as will be described below, commands related to modeling that are input by handwriting can be recognized and analyzed to perform modeling by this processing.

As described above, the system for providing education of the present disclosure has ability that performs modeling on the basis of predetermined fundamental data and provides a created model to a user, and such a model can be effectively and efficiently provided through control optimized for the system for providing education. For this reason, a control method optimized for the system shown in FIGS. 1 and 2 have been invented and will be described below additionally with reference to relevant drawings. Unless specifically described otherwise, the description about FIGS. 1 and 2 is fundamentally included and referred to in the description and figures related to the following control method, that is, the method for providing education.

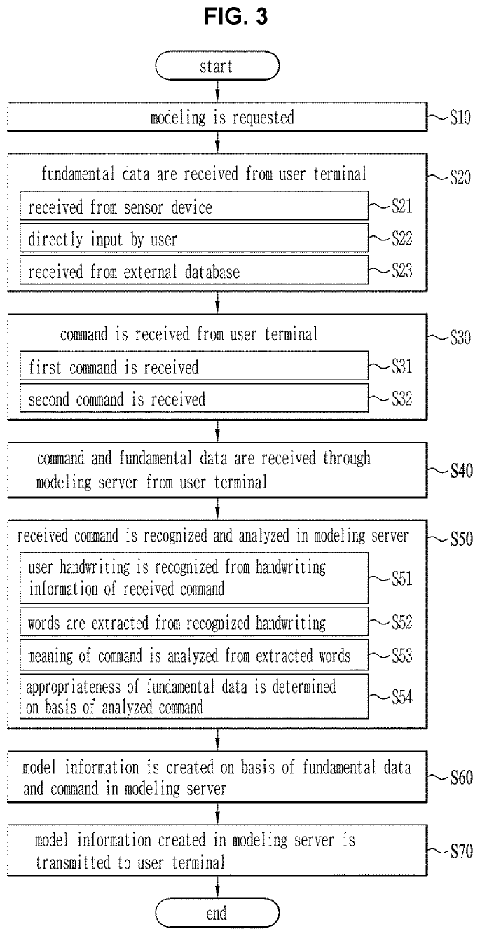

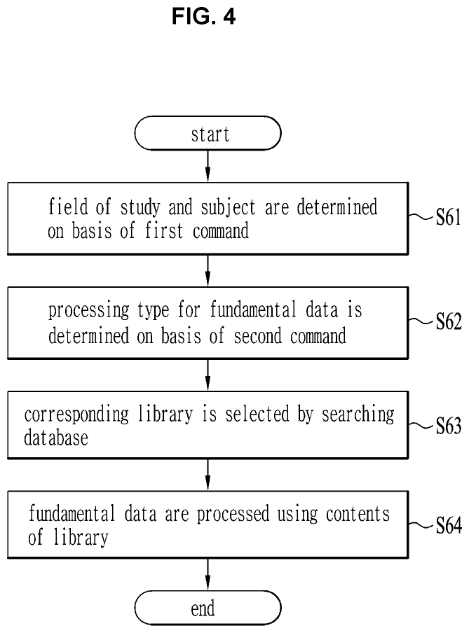

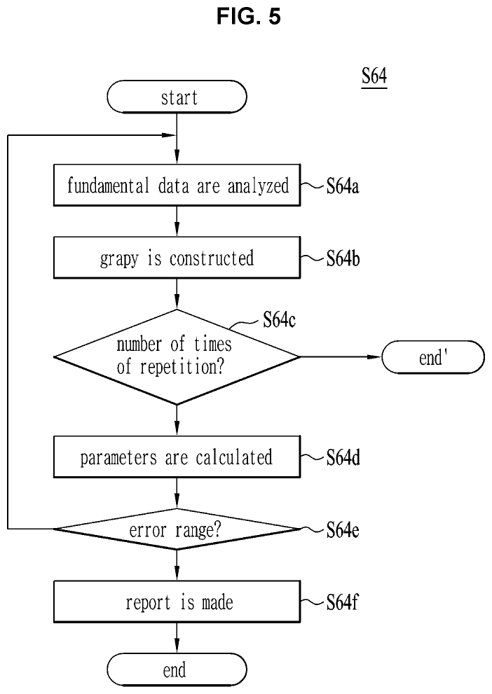

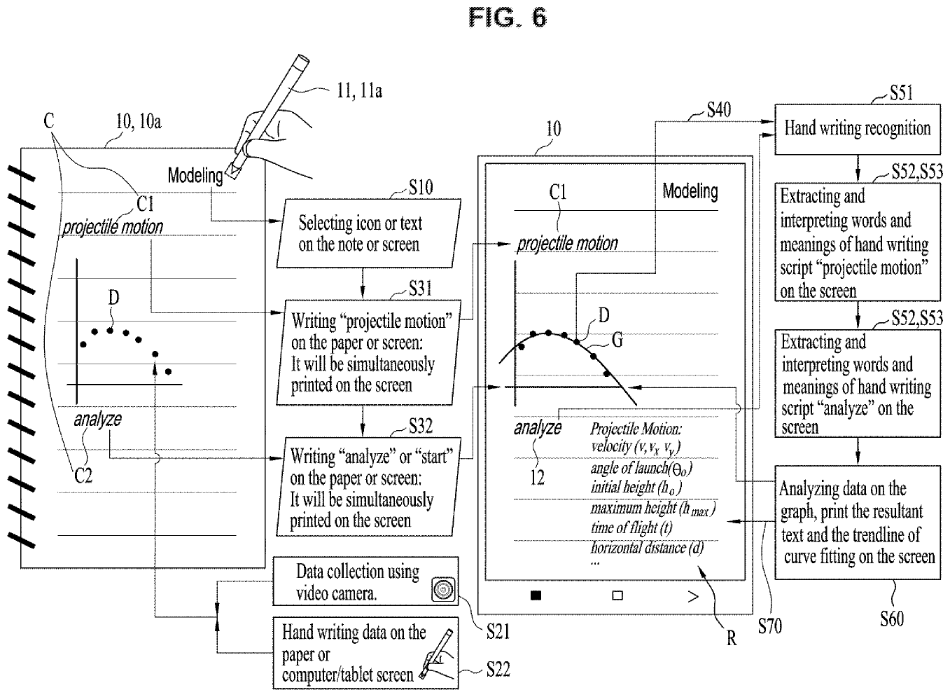

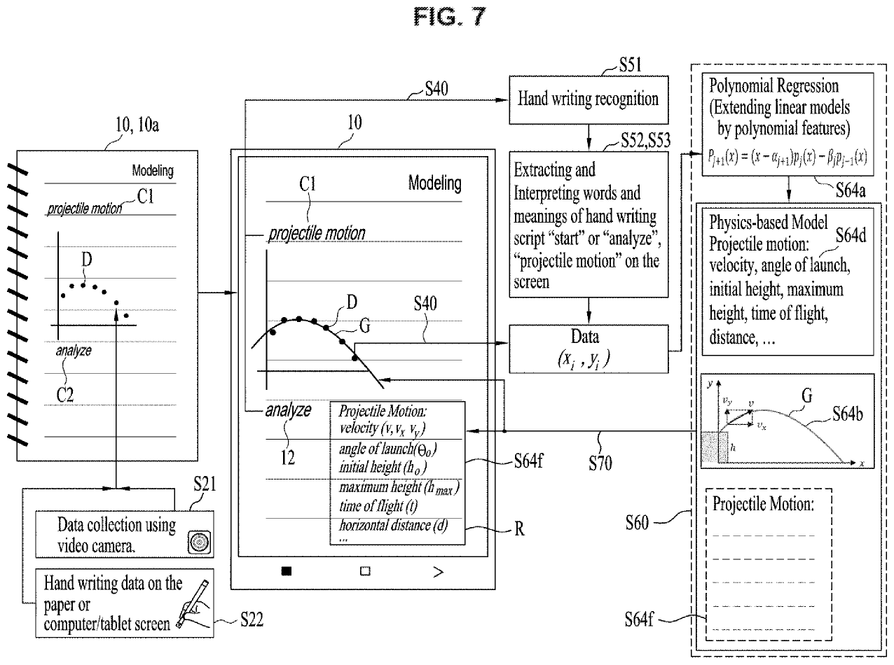

FIG. 3 is a flowchart showing a method for providing education using modeling according to the present disclosure. FIG. 4 is a flowchart showing a model information creation step in detail in the method for providing education of FIG. 3 and FIG. 5 is a flowchart showing in detail a fundamental data process step of FIG. 4. FIGS. 6 and 7 are schematic views showing examples of the method for providing education of the present disclosure. In the figures, FIG. 6 shows steps that are performed by the user terminal 10 in more detail in the method for providing education and FIG. 7 shows steps that are performed by the modeling server 20 in more detail in the method for providing education. Since FIGS. 6 and 7 show actual examples of the steps in the flowchart shown in FIG. 5, the steps shown in FIGS. 3 to 5 are described with the examples shown in FIGS. 6 and 7.

The control method of a system for providing education, that is, the method for providing education to be described hereafter can control operation of the components, that is, various devices and parts described with reference to FIGS. 1 and 2 and can provide functions intended on the basis of the operation. Accordingly, the operation and functions to be described hereafter with the method may be considered as not only as the features of the control method, but the functional features of all relevant components.

As will be described below, the modeling server 20 performs modeling that is the most important function, and controls the user terminal 10 to perform modeling and provide a created model. Accordingly, the method for providing education of the present disclosure can be controlled and performed substantially by the modeling server 20. For this reason, some steps are performed by the user terminal 10, but, in terms of the entirety, all of the steps of the method for providing education may be described as features of the modeling server 20, accurately, the control module 21 that controls the modeling server. In addition, the transmission server 20, particularly, the control module 21 therefor may include a control device for performing requested control operation. The control device is fundamentally implemented as a processor, may be referred to with various names such as a controller and a controlling unit, and can control all of the components of the system for providing education to perform operation according to the control method. Accordingly, in terms of details, a control device, that is, a processor substantially control all of the methods and modes to be described below in the present disclosure, whereby all of the steps to be described hereafter may be considered also as features of the processor that is a control device. For this reason, even though not described as being performed by the modeling server 20, the control module 21, and the control device (processor), the following steps and the detailed features thereof all may be understood as the features of the modeling server 20, the control module 21, and the control device (processor). The description about FIGS. 1 and 2 is referred to for the structural features and operation thereof in the following description of the control method, and accordingly, repeated description thereof is omitted.

Further, as well known in the art, since transmission and reception of predetermined information are relatively performed between relevant devices, it should be understood that the following description includes variation of the relative functions of corresponding devices in transmission and reception of predetermined information. For example, in the following description, transmission of predetermined information from the user terminal 10 to the modeling server 20 means also reception at the modeling server 20 from the user terminal 10.

First, referring to FIG. 3, a user can request modeling using the user terminal 10 (S10). Such a request step S10 may correspond to a process of starting and preparing modeling in the system for providing education. By this request step S10, the user terminal 10 and the modeling server 20 can recognize start of modeling and prepare following substantial modeling steps.

For example, as shown in FIG. 6, a user can request modeling by selecting an icon or a text “Modeling” on the smart paper 10a using the pen 11a. Alternatively, a user can request modeling by selecting an icon or a text “Modeling” on the display of the user terminal 10, that is, on the screen thereof using the pen 11. As described above, input using the smart pen 11a and the smart paper 10a is converted first into electronic data and then transmitted to the user terminal 10, and accordingly, it is possible to achieve substantially the same result as input using the stylus pen 11 through the user terminal 10. Accordingly, in the following description, only input using the user terminal 10 and the pen 11 is described for the convenience of description, but this includes input by the smart pen 11a and the smart paper 10a. Besides the pens 11 and 11a, other input and pointing tools, for example, a finger of a user and a mouse may be used for requested input, and using the pens 11 and 11a includes such another input or using point tools unless specifically stated otherwise.

When request for modeling is received in this way, the user terminal 10 can display a user interface (UI) for modeling on the display thereof as a process of preparing modeling. For example, the user terminal 10 may provide the user with a preparation interface for inputting and displaying fundamental data for modeling. The preparation interface, as shown in FIGS. 6 and 7, may include axes of coordinates for inputting fundamental data, and other windows, icons, buttons, etc. for inputting fundamental data may also be included in the preparation interface. The preparation interface may be stored in advance in the user terminal 10. Alternatively, the preparation interface, as will be described below, may be created in the modeling server 20 to be fitted to requested modeling, accurately, the field of study and the subject thereof, and transmitted to the user terminal 10.

When the request step S10 is finished, the user terminal 10 can receive fundamental data D for modeling (S20).

In the reception step S21, as shown in FIGS. 6 and 7, the fundamental data D may be obtained from the sensors 12 provided for the user terminal 10 (S21). The sensors 12 may be external sensors fundamentally disposed outside the user terminal 10 and configured to communicate with the terminal 10. When the user terminal 10 is a smart device, the sensors 12 may be built-in sensors of the user terminal 10. The sensors 12 can directly sense external phenomenon, convert the external phenomenon into digital data, and transmit the digital data to the user terminal 10.

Alternatively, the fundamental data D may include data directly input to the user terminal 10 by a user. For example, as shown in FIGS. 6 and 7, a user can directly input fundamental data D obtained through the provided preparation UI (e.g., axes of coordinates) through handwriting using the pen 11. That is, a user can input values, which are obtained by directly observing and measuring external phenomenon, into the user terminal 10 as fundamental data D. Alternatively, the user terminal 10 may receive fundamental data from an external database or may receive fundamental data through communication with other external devices. In this case, the user terminal 10 receives values, which are obtained in advance from the external devices and database, as fundamental data D.

In this reception step S20, the detailed steps S21 to S22 may be individually performed or, if necessary, may be all performed. The fundamental data D received through the reception step S20 generally may include measurement values for various variables. For example, as for science, temperature, humidity, a distance, a height, etc. may be collected as the fundamental data D. Further, the fundamental data D received by the reception step S20, as shown in FIGS. 6 and 7, may be displayed on the user terminal 10, whereby the user can easily know the current states of the collected fundamental data D.

When the data reception step S20 is finished, the user terminal 10 can receive a command C (C1 and C2) from the user (S30).

The command C may be configured to give an instruction of modeling related to the received fundamental data D. As discussed above, in order to enable real-time response and quick adaptation to the education system, the system and method for providing education of the present disclosure may be configured to use, preferably, handwriting input for detailed input other than simple selection. Accordingly, the command may be input directly into the user terminal by handwriting of a user. The user terminal 10, as described above, can sense variation of pressure or static electricity that is generated in handwriting, and can recognize and display the handwriting on the display on the basis of the sensed variation (i.e., an electrical signal). The user terminal 10 can create data corresponding to handwriting, that is, handwriting information on the basis of variation of pressure of static electricity and other sensed values. For example, the handwriting information may include not only the coordinate values and intensity of handwriting, but the angular velocity, acceleration, etc. of the pen 11. As will be described below, the handwriting information may be used to transmit the input command C to another device, that is, the modeling server 20. Meanwhile, in the command reception step S30, the command C may be input using other input tools such as a keyboard and a microphone (voice input) instead of handwriting. Next, only handwriting input is stated for input of the command C, but it should be understood that input of the command C includes also input of the command C by common input tools and devices unless specifically described otherwise.

In the command reception step S30, a user can input a first command C1 first into the user terminal 10 (S21). The first command C1 is configured to designate a field of study to be modeled and a subject in the field of study. For example, referring to FIGS. 6 and 7, the user can input “projection motion” into the user terminal 10 as the first command C1 using the pen 11 (S31). The first command C1 “projection motion” is an item included in mechanics of physics, and accordingly, it is possible to designate physics as a field of study and mechanics as a specific subject in physics. The first command C1 “projection motion” itself may designate also a specific item in the designated field of study and subject, that is, a substantial target of modeling and the result. Similarly, a user can designate other field of study, subject, and item to be modeled by the first command C1, for example, a specific subject of mathematics, chemistry, biology, and sociology and a specific item in the subject.

The user can input a second command C2 into the user terminal 10 after inputting the first command C1 (S32). The second command C2 may be configured to designate a processing type for the received fundamental data D under the field of study and subject designated by the first command C1. For example, referring to FIGS. 6 and 7, the user can input “analyze” as the second command C2 into the user terminal 10 using the pen 11 (S32). The second command C2 “analyze” can give an instruction to create a model by analyzing the fundamental data D by means of the modeling server 20. Similarly, the user can designate another processing type for the fundamental data D through the second command C2. For example, a second command C2 “parameter” can give an instruction to create a model by extracting parameters first from the fundamental data by means of the modeling server 20.

When the user terminal 10 receives fundamental data D and a command C requested for modeling through the data reception and command reception steps S20 and S30, the user terminal 10 can transmit the received fundamental data D and command C to the modeling server 20 (S40). That is, the modeling server 20 can receive the fundamental data D and command C from the user terminal 10 to create a model (S40).

In the reception step S40, the user terminal 40 can transmit the fundamental data D and command C at one time to the modeling server 20 after reception of them is finished. Alternatively, the user terminal 10 may transmit received data D and command C to the modeling server 20 immediately every time the fundamental data D and command C are received. The fundamental data D are received in a digital or electrical type in the user terminal 10, so the fundamental data D can be immediately transmitted to the modeling server 20 from the user terminal 10. Meanwhile, a command C input in an analog type, that is, through handwriting, as described above, can be transmitted to the modeling server 20 as handwriting information that is digital or electrical data of the input handwriting.

It is required to clearly find out the meaning of a command C input through handwriting in order to perform modeling. Accordingly, after the reception step S40, the modeling server 20 can recognize and analyze first the received handwriting command C to perform modeling (S50). As described above, the modeling server 20 is configured to receive handwriting information of a command C input through handwriting from the user terminal 10 such that the recognition module 23 therein substantially recognizes and analyzes the handwriting information under control of the control module 21.

In more detail, in the recognition and analysis step S50, the modeling server 20, that is, the recognition module 23 can recognize first handwriting by the user from the handwriting of the command C (S51). The recognition module 23 can extract specific words from the recognized handwriting and can analyze the meaning of the command C from the extracted words (S52 and S53). For example, the recognition module 23 of the modeling server 20 recognizes the handwriting by the user from the handwriting information, thereby being able to recognize the geometrical shapes of “projectile motion” and “analyze” that are the first and second commands C1 and C2, that is, the shapes of the handwriting (S51). Thereafter, the recognition module 23 can extract “projectile motion” and “analyze” that are substantial words from the recognized handwriting shapes, and can analyze the meanings on the basis of the extracted words (S52 and S53). The modeling server 20, that is, the recognition module 23 may apply artificial intelligence (AI) and machine learning (ML) techniques to the series of recognition and analysis steps S51 to S53.

Meanwhile, when the command C is analyzed, the modeling server 20 can determine appropriateness of the fundamental data on the basis of the analyzed command C (S54). In more detail, the modeling server 20 can determine whether the contents and input type of the fundamental data D coincide with the request or instruction of the analyzed command C, that is, the field of study, subject, item, and processing type requested by the analyzed command D. That is, it is possible to determine whether modeling requested by a command C is possible on the basis of given fundamental data D.

When the contents of fundamental data D are inappropriate, for example, when some data required for modeling are missing, the modeling server 20 can request the user terminal 10 to transmit again the fundamental data D, particularly, the missing data. This request is displayed with detailed information on the user terminal 10, and the user can transmit fundamental data D created again to be appropriate, including the missing data, to the modeling server 20 through the steps S20 and S40 using the terminal 10. When the input type of the fundamental data D is inappropriate, for example, when the fundamental data D has been constructed in the basis of another coordinate system (e.g., an orthogonal coordinate system) that is not the coordinate system (e.g., a polar coordinate system) required fro modeling, the modeling server 20 can request the user terminal 10 to transmit again fundamental data D together with an appropriately corrected new preparation UI. This request is displayed with detailed information and the transmitted preparation UI on the user terminal 10, and the user can transmit fundamental data D created again to be appropriate to the modeling server 20 through the steps S20 and S40 using the user terminal 10 and the new preparation UI displayed on the terminal 10.

Thereafter, the modeling server 20 can create a model and relevant information (i.e., model information) on the basis of the fundamental data D and the command C (S60). That is, the modeling server 20 can create model information in accordance with the field of study, subject, item, and processing type designated in the command C using the received fundamental data D, and the model information may include the created model and the relevant information.

In more detail, referring to FIG. 4, in the creation step S60, the modeling server 20 can determine first a field of study to be modeled and a subject in the field of study (including an item in the subject) from the analyzed first command C1 (S61). The modeling server 20 can determine the processing type for the received fundamental data D from the analyzed second command C2 (S62). For example, referring to FIGS. 6 and 7, the modeling server 20 can determine that the field of study for modeling and the subject correspond to mechanics of physics and that the target of modeling is “projectile motion” from the analyzed first command C1 “projectile motion”. The modeling server 20 can determine that a model should be created by analyzing fundamental data, from the analyzed second command “analyze”.

Thereafter, the modeling server 20 can select a corresponding library on the basis of the determined field of study and subject and the determined item (S63). In more detail, the modeling server 20, that is, the control module 21 thereof can determine a field of study and a subject first by searching the database in the database module 22 shown in FIG. 2, and can specific a library corresponding to the item designated in the first command C1 from libraries under the determined field and subject. For example, referring to FIGS. 6 and 7, the modeling server 20 can determine first a field of study and a subject as “physics” and “mechanics” from the first command C1 “projectile motion”, and can search a physics database in the database module 22. Thereafter, the modeling server 20 can select a library corresponding to “projectile motion” from the libraries in the subject, that is, mechanics in the physics database.

Thereafter, the modeling server 20 can process the fundamental data D using the contents of the selected library (S64). That is, the modeling server 20 can process the fundamental data D to create model information in accordance with the determined processing type (i.e., the second command C2) using the contents in the selected library.

In more detail, referring to FIG. 5, the modeling server 20 can analyze first the received fundamental data D in the processing step S20 (S64a). The library selected for modeling includes a relevant theory, a relevant formula, a modeling technique based on the formula, a method of calculating parameters, etc., and accordingly, the analysis step S64a can be performed using these contents. For example, as shown in FIG. 7, the fundamental data D can be processed using a polynominal regression technique that is included in a library and is appropriate to analysis of projectile motion.

The modeling server 20 can construct a graph G using the analyzed fundamental data D (S64b). For example, as shown in FIGS. 6 and 7, the modeling server 20 can construct a graph G corresponding to projective motion on the basis of the analyzed fundamental data D.

Meanwhile, the processing step S20 may use regression analysis that uses repeated calculation for accuracy of modeling, and an appropriate number of times of repetition may be set in advance in such regression analysis. Accordingly, the modeling server 20 can calculate the number of times of repetition (S64c) and can end additional calculation, that is, the processing step S20 when the number of times of repetition is a preset value or more.

Meanwhile, the modeling server 20 can calculate various parameters related to the model created in the previous steps S64a and S64b when the number of times of repetition 64c is less than the preset value (S64d). These parameters may be generally calculated on the basis of the graph G obtained in the previous step S64b. For example, as shown in FIG. 7, the modeling server 20 may calculate various parameters such as a velocity, a height, time, and a distance related to projectile motion.

After calculating parameters, the modeling server 20 can calculate errors of the calculated parameters (S64e). Various techniques can be used to calculate the errors, and for example, a loss function may be applied. If a calculated error is a preset value or more, it can be determined that there is a considerable error. Accordingly, the modeling server 20 can repeat the steps 64a to 64d performed previously.

Meanwhile, when a calculated error is less that the preset value, it can be determined that there is no error. Accordingly, the modeling server 20 can make a report R about the performed modeling. The report R may include information about the graph and the parameters obtained in the previous steps S64b and S64d. For example, referring to FIG. 7, the modeling server 20 may create a report R including the parameters calculated in modeling of the performed projectile motion, and other information.

When a series of model information creation step S60 is finished, as described above, the modeling server 20 can transmit the created model information to the user terminal 10 (S70). The model information that is transmitted may include the graph G and the report R made in modeling. For example, as shown in FIGS. 6 and 7, the modeling server 20 can transmit the graph G and the report R to the user terminal 10 as model information of the requested projectile motion. The transmitted model information G and R can be displayed with an appropriate UI on the user terminal 10. The user may further show detailed information by adjusting the model information G and R. Accordingly, a user can designate modeling for a field of study and a subject, which he/she wants, for fundamental data D that he/she obtained from specific phenomenon in person, and accordingly, the user can be induced to actively participate in study of the field of study. Further, as the result of modeling a designated filed of study and subject, that is, by receiving in real time the model information G and R from the modeling server 20, it is possible to quickly and deeply understand the field of study and the subject.

The detailed description should not be construed as being limited in all respects and should be construed as an example. The scope of the present disclosure should be determined by reasonable analysis of the claims and all changes within an equivalent range of the present disclosure is included in the scope of the present disclosure.

What is claimed is:

1. A system for providing education using modeling, the system comprising:
a user terminal; and
a modeling server connected with the user terminal such that communication is possible, and configured to construct models for various fields of study on the basis of predetermined data,
wherein the modeling server is configured to:
receive fundamental data from the user terminal;
receive a command giving an instruction related to the received fundamental data from the user terminal;
create model information corresponding to a field of study designated by the command using the received fundamental data; and
transmit the created model information to the user terminal.

2. The system of claim 1, wherein the fundamental data include data obtained from sensor devices provided for the user terminal.

3. The system of claim 1, wherein the fundamental data include data directly input into the user terminal by a user.

4. The system of claim 1, wherein the command includes:
a first command designating a field of stud to be modeled and a subject in the field of study; and
a second command designating a processing type for the received fundamental data under the designated field of study and subject.

5. The system of claim 1, wherein the command includes handwriting information created by handwriting on the user terminal by a user.

6. The system of claim 5, wherein the modeling server is configured to:
recognize handwriting by the user from handwriting information of the command;
extract words from the recognized handwriting; and
analyze meanings of the command on the basis of the extracted words.

7. The system of claim 4, wherein the modeling server, in order to create the model information, is configured to:
determine a field of study to be modeled and a subject tin the field of study on the basis of the first command;
determine a processing type for the received fundamental data on the basis of the second command;
select a library corresponding to the determined field of study and subject by searching a database in a database module of the modeling server on the basis of the field of study and the subject; and
process the fundamental data to create the model information in accordance with the determined processing type using contents in the selected library.

8. The system of claim 7, wherein the modeling server, in order to process the fundamental data, is configured to:
analyze the fundamental data;
construct a graph using the analyzed fundamental data; and
calculate various parameters related to the created model.

9. The system of claim 8, wherein the modeling server is configured to further make a report including information about the graph and the parameters.

10. The system of claim 9, wherein the modeling server is configured to transmit the constructed graph and report to the user terminal as the model information.
